(19) United States
(12) Patent Application Publication
(10) Pub. No.: US 2013/0016802 A1
(43) Pub. Date: Jan. 17, 2013

(54) OSCILLATION POWER RANGE MONITOR AND METHOD OF CHECKING SOUNDNESS THEREOF

(71) Applicants: Takayoshi FURUSAWA, Tokyo (JP); Norihiro Umemura, Tokyo (JP); Tadashi Miyazaki, Kanagawa (JP)

(72) Inventors: Takayoshi FURUSAWA, Tokyo (JP); Norihiro Umemura, Tokyo (JP); Tadashi Miyazaki, Kanagawa (JP)

(73) Assignee: KABUSHIKI KAISHA TOSHIBA

(21) Appl. No.: 13/354,995

(22) Filed: Jan. 20, 2012

(30) Foreign Application Priority Data
Jan. 21, 2011 (JP) 2011-011044

(51) Int. Cl. G21D 3/08

(52) U.S. Cl. 376/217

(57) ABSTRACT

An oscillation power range monitor has: an averaging section that assigns a plurality of LPRM readings input filtered to remove noise thereof from local power range monitors to calculate cell average value of the LPRM readings assigned to each cell; a time average processing section that calculates a cell time average value from the average value of each cell; a normalized cell value computing section that computes the normalized cell value for each cell from the cell time average value and the cell average value; a trip determining section that receives the normalized cell value, monitors oscillations of each cell output and outputs a scram trip when the normalized cell value exceeds a predetermined value; and an abnormality determining section that assigns a plurality of LPRM readings input and determines abnormality of each LPRM reading assigned to each cell based on the oscillations of the LPRM reading.

### CROSS-REFERENCE TO RELATED APPLICATIONS

This application is based upon and claims the benefit of priority from Japanese Patent Application No. 2011-011044 filed on Jan. 21, 2011, the entire content of which is incorporated herein by reference.

### FIELD

Embodiments described herein relate generally to an oscillation power range monitor to be used as reactor core stability measures of a boiling water reactor and a method of checking the soundness thereof.

### BACKGROUND

Oscillation power range monitors (to be referred to as OPRM hereinafter) are being employed for boiling water reactors as reactor core stability measures. Such an OPRM is disclosed in Jpn. Pat. Appln. Laid-Open Publication No. 04-335197, the entire content of which is incorporated herein by reference. An OPRM system incorporating such an OPRM is designed to suppress neutron flux oscillations before the fuel soundness is damaged. The OPRM system detects neutron flux oscillations that are oscillations specifically characteristic relative to nuclear thermal hydraulic stability, and causes a nuclear reactor scram to take place.

An OPRM system of a nuclear power plant is configured to have four sections and the OPRM system of each section includes local power range monitors (to be referred to as LPRMs hereinafter), LPRM detectors for 52 channels and an OPRM.

Each of the OPRMs receives the LPRM detector signals of the LPRM detectors for 52 channels belonging to a section from the LPRMs Each of the received LPRM detector signals is filtered to remove the noise by a noise removing filter and input to a bypass processing section as individual LPRM reading.

The LPRM reading is subjected to bypass processing when it is the LPRM reading of an LPRM detector that is not in operation and bypassed or when the LPRM reading shows a low value of, for example, not greater than 5% according to abnormality of LPRM function.

The LPRM readings output from the bypass processing section are assigned to 44 OPRM cell averaging sections, each being formed by using LPRM detectors for 4 or 3 channels, and the cell average value is determined for each OPRM cell from the LPRM readings of the LPRM detectors of the OPRM cell and subjected to a cell average value/cell time average value calculation for normalization. The outcome of the calculation is output to a trip determining section as normalized cell value. The trip determining section senses the amplitude and the period of each normalized cell value and outputs a trip signal when they exceed determination threshold values.

With the conventional OPRM, when any of the LPRM detectors of an OPRM cell (to be referred to simply as cell hereinafter) is bypassed or the LPRM reading shows a low value of, for example, not greater than 5%, the LPRM reading is excluded from the downstream cell averaging process because the LPRM is bypassed and only the LPRM readings of the LPRM detectors that are not bypassed are subjected to the averaging process of the cell.

However, there can be instances where an LPRM detector is not bypassed by the bypass processing section when the LPRM reading is out of phase or continuously shows a constant value although the LPRM reading is not a low value of not greater than 5% because the LPRM detector has fallen into an abnormal condition. In such a case, the abnormal LPRM reading is included in the averaging process and the outcome of the calculation involving the abnormal reading is output to the trip determining section. Then, the trip determining section determines a trip by detecting a change in the cell value that is the average value of the LPRM readings for 4 channels in time series, consequently giving rise to a possibility of erroneous determinations.

### BRIEF DESCRIPTION OF THE DRAWINGS

The above and other features and advantages of the present invention will become apparent from the discussion hereinbelow of specific, illustrative embodiments thereof presented in conjunction with the accompanying drawings, wherein:

FIG. 1 is a block diagram of an OPRM system according to a first embodiment, illustrating the configuration thereof;

FIG. 2 is a block diagram of the amplitude abnormality determining section of FIG. 1;

FIG. 3 is a graph schematically illustrating the operation of the amplitude excess determining section of FIG. 2;

FIG. 4 is a block diagram of the determination logic of the non-oscillating channel detecting section of FIG. 2;

FIG. 5 is a graph schematically illustrating the operation of the ABA trip determining section;

FIG. 6 is a graph schematically illustrating the operation of the GRA trip determining section;

FIG. 7 is a graph schematically illustrating the operation of the PBDA trip determining section;

FIG. 8 is a block diagram of an OPRM according to a second embodiment, illustrating the configuration thereof;

FIG. 9 is a block diagram of the period abnormality determining section of FIG. 8;

FIG. 10 is a graph schematically illustrating the operation of the period measuring section of FIG. 8;

FIG. 11 is a block diagram of the determination algorithm of the dispersion detecting section of FIG. 8; and

FIG. 12 is a block diagram of an OPRM according to a third embodiment, illustrating the configuration thereof.

### DETAILED DESCRIPTION

In view of the above-identified problem, it is therefore an object of the present embodiments to provide an oscillation power range monitor that can improve the reliability of trip determination and a method of checking the soundness thereof.

According to an embodiment, an oscillation power range monitor comprises:

an averaging section that assigns a plurality of LPRM readings input from local power range monitors to cells operating as computing units and calculates cell average value of the LPRM readings assigned to each cell; a time average processing section that receives the average value of each cell as input and calculates a cell time average value; a normalized cell value computing section that receives the cell time average value and the cell average value as input and computes a normalized cell value for each cell; a trip determining section that receives the normalized cell value as input, monitors oscillations of output of each cell and outputs a scram trip when the normalized cell value exceeds a predetermined value; and an abnormality determining section that determines abnormality of each of the LPRM readings assigned to each cell on the basis of the oscillations of the LPRM reading.

According to another embodiment, a method of checking the soundness of an oscillation power range monitor comprises: an averaging step of assigning a plurality of LPRM readings input from local power range monitors to cells operating as computing units and calculating cell average values of the LPRM readings assigned to each cell; a time average processing step of receiving the average value of each cell as input and calculating a cell time average value; a normalized cell value computing step of receiving the cell time average value and the cell average value as input and computing the normalized cell value for each cell; a trip determining step of receiving the normalized cell value as input, monitoring oscillations of the output of each cell and outputting a scram trip when the normalized cell value exceeds a predetermined value; and an abnormality determining step of determining abnormality of each of the LPRM readings assigned to each cell on the basis of the oscillations of the LPRM reading.

Now, preferred embodiments of oscillation power range monitor and those of method of checking the soundness thereof will be described below by referring the accompanying drawings. Throughout the drawings, same or similar sections are denoted by the same reference symbols and will not be described repeatedly.

### First Embodiment

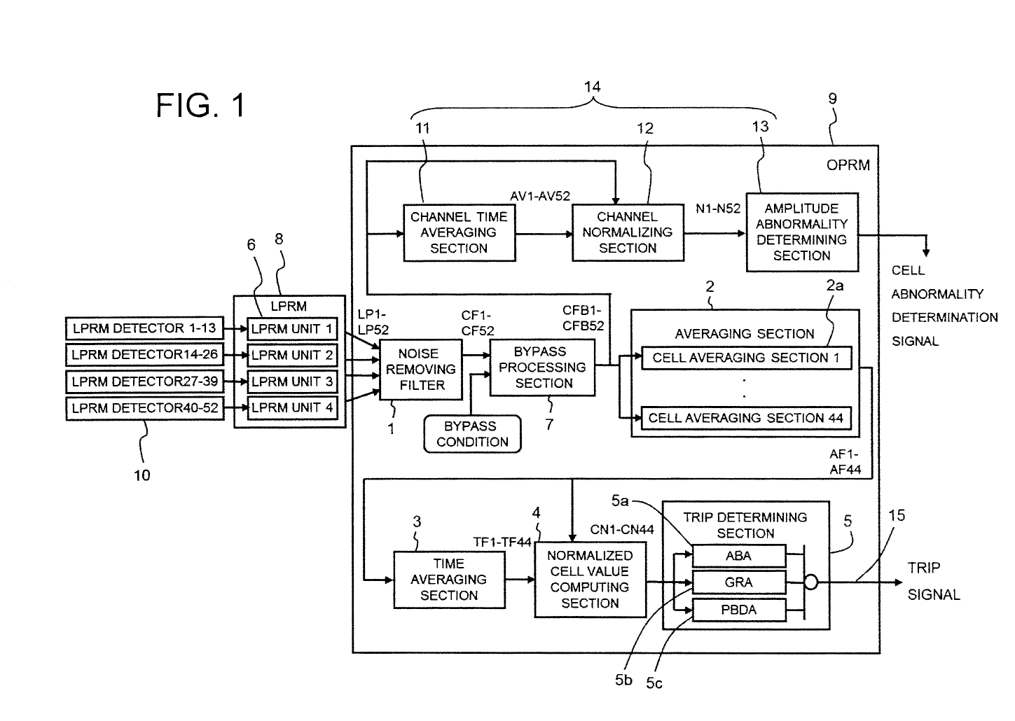

FIG. 1 is a block diagram of an OPRM system according to the first embodiment of the present invention, illustrating the configuration thereof.

Firstly, the configuration of an OPRM 9 will be described below by referring to FIG. 1.

The OPRM system of a nuclear power plant has four sections, although one of them of the OPRM system is illustrated in FIG. 1. The OPRM system has LPRM detectors 10 for 52 channels, an LPRM 8 and an OPRM 9. The LPRM 8 is formed by four LPRM units 6 and each of the LPRM units 6 contains 13 LPRM modules, and 13 LPRM detectors 10 are connected respectively to the LPRM modules. The current signals indicating neutron fluxes detected by the LPRM detectors 10 for 52 channels are subjected to voltage conversion, filtering, signal processing and so on in the respective LPRM modules. The LPRM readings that are subjected to signal processing are digitized in the LPRM units 6 and the LPRM detector signals are output to the OPRM 9 at regular time intervals.

The OPRM 9 receives LPRM detector signals LP1 to LP52 of the LPRM detectors 10 for 52 channels belonging to one section. The received LPRM detector signals LP1 to LP52 are filtered by a noise removing filter 1 to remove the noises thereof and produce LPRM readings CF1 to CF52, which are then input to a bypass processing section 7. The LPRM reading is subjected to bypass processing when it is the LPRM reading of an LPRM detector that is not in operation and bypassed or when the LPRM reading shows a low value of, for example, not greater than 5% according to abnormality of LPRM function.

The LPRM readings CFB1 to CFB52 output from the bypass processing section 7 are input to averaging section 2 and assigned in the averaging section 2 to 44 cell averaging sections 2a, each being formed by using LPRM detectors 10 for 4 or 3 channels. The cell averaging sections 2a calculate the respective cell average values AF1 to AF44 in the height direction of the LPRM readings of the LPRM detectors 10 of each cell.

The cell average values AF1 to AF44 are output to normalized cell value computing section 4 by way of time average processing section 3. The time average processing section 3 calculates the cell time average values TF1 to TF44. The normalized cell value computing section 4 makes a calculation of each cell average value/cell time average value in the height direction to obtain normalized cell values CN1 to CN44, which are then output to trip determining section 5.

The normalized cell values CN1 to CN44 of each cell are input to the trip determining section 5. The trip determining section 5 of the cell monitors the output oscillations by means of three diverse algorithms, which are amplitude base trip determining section (to be referred to as ABA trip determining section hereinafter) 5a, growth rate trip determining section (to be referred to as GRA trip determining section hereinafter) 5b and period base trip determining section (to be referred to as PBDA trip determining section hereinafter) 5c. Then, the trip determining section 5 outputs a trip signal 15 when any of the normalized cell values CN1 to CN44 exceeds a predetermined threshold value.

The OPRM 9 additionally has an oscillation amplitude abnormality determining section 14 for detecting an LPRM reading that does not show a predetermined oscillation pattern on the basis of the LPRM readings assigned to each cell.

The oscillation amplitude abnormality determining section 14 includes a channel time averaging section 11, a channel normalizing section 12 and an amplitude abnormality determining section 13.

The LPRM readings CFB1 to CFB52 for 52 channels that are made to pass through the noise removing filter 1 and the bypass processing section 7 are input to the channel time average processing section 11, which then operates for a time averaging process to determine channel time average values AV1 to AV52 and outputs them to channel normalizing section 12.

The channel normalizing section 12 determines the channel normalized values N1 to N52 by dividing the LPRM readings CFB1 to CFB52 for 52 channels that are made to pass through the noise removing filter and the bypass processing section 7 by the respective channel time average values AV1 to AV52 and outputs them to the amplitude abnormality determining section 13.

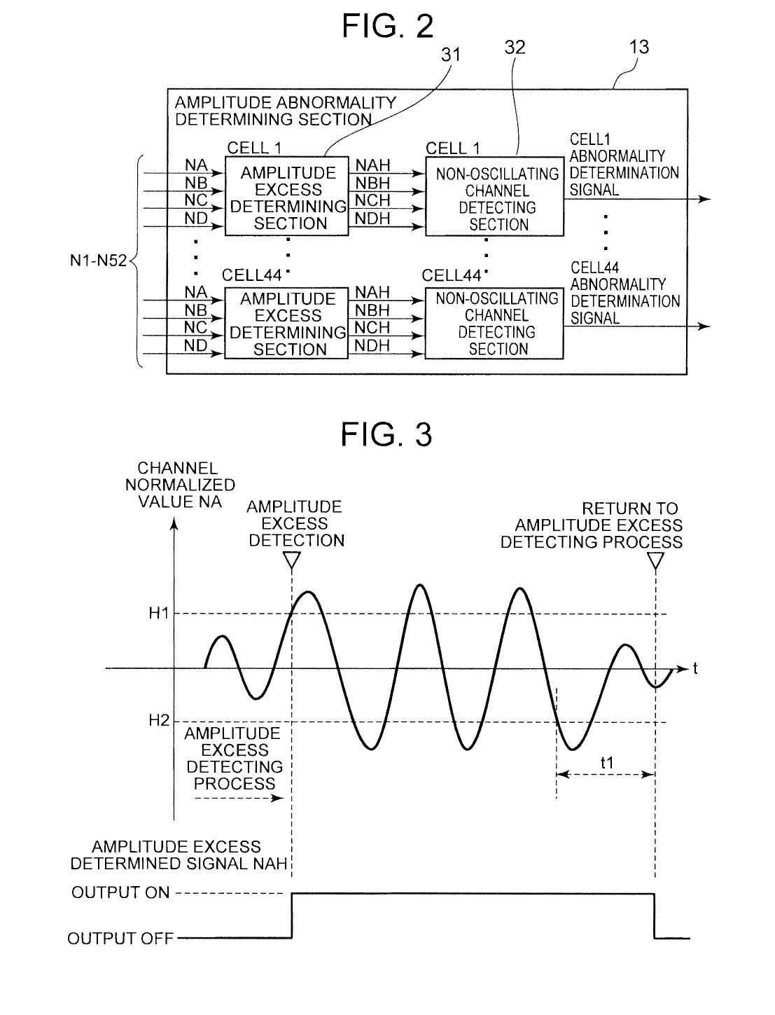

Now, the amplitude abnormality determining section 13 will be described below by referring to FIG. 2.

FIG. 2 is a block diagram of the amplitude abnormality determining section 13 of FIG. 1.

As shown in FIG. 2, the amplitude abnormality determining section 13 distributes the channel normalized values N1 to N52 input to 44 amplitude excess determining sections 31 for the 44 respective cells. The four channel normalized values NA, NB, NC and ND that are input to each amplitude excess determining section 31 correspond to the outputs of the LPRM detectors 10 arranged in the four regions in the height direction A, B, C and D of the LPRM detector assembly. Each amplitude excess determining section 31 determines whether each the four channel normalized values NA, NB, NC and ND exceeds a respective determination threshold value or not and outputs the result of determination to a non-oscillating channel detecting section 32.

Now, the amplitude excess determining section 31 will be described below by referring to FIG. 3.

FIG. 3 is a graph schematically illustrating the operation of the amplitude excess determining section of FIG. 2. While the executing process of the channel normalized value NA is described here, the amplitude excess determining section executes a similar process for NB, NC and ND each.

As shown in FIG. 3, the amplitude excess determining section 31 compares the channel normalized value NA with determination threshold value H1. If the channel normalized value NA exceeds the determination threshold value H1, the amplitude excess determining section 31 starts outputting specified amplitude exceeding signal NAH to the non-oscillating channel detecting section 32.

Then, the amplitude excess determining section 31 compares the channel normalized value NA with determination threshold value H2 and checks whether the channel normalized value NA falls below the determination threshold value H2 in a predetermined time period t1 or not. If the channel normalized value NA falls below the determination threshold value H2 in the time period t1, the amplitude excess determining section 31 keeps on outputting NAH and then compares NA with the determination threshold value H1. If NA exceeds the determination threshold value H1 in the time period t1, the amplitude excess determining section 31 keeps on outputting NAH.

The reason why the determination threshold values H1 and H2 are set is to remove the influence of the fluctuations and noise that each channel normalized value contains and to selectively detect oscillations. A value similar to the determination threshold value S1 for ABA trip, which may typically be equal to 1.1 as ratio to the determination threshold value S1, is selected for an absolute value of the determination threshold values H1, 112 each.

The amplitude excess determining section 31 keeps on outputting NAH by repeating the above process. If NA does not exceed both the determination threshold values H1 and H2 in predetermined time period t1, it stops outputting NAH and returns to the amplitude excess detecting process. The above-described operations are also conducted to each of the channel normalized values NB, NC and ND and specified amplitude exceeding signals NBH, NCH and/or NDH are output to the non-oscillating channel detecting section 32 when the above conditions are met. The non-oscillating channel detecting section 32 determines the state of input of each of the four specified amplitude exceeding signals NAH, NBH, NCH and NDH.

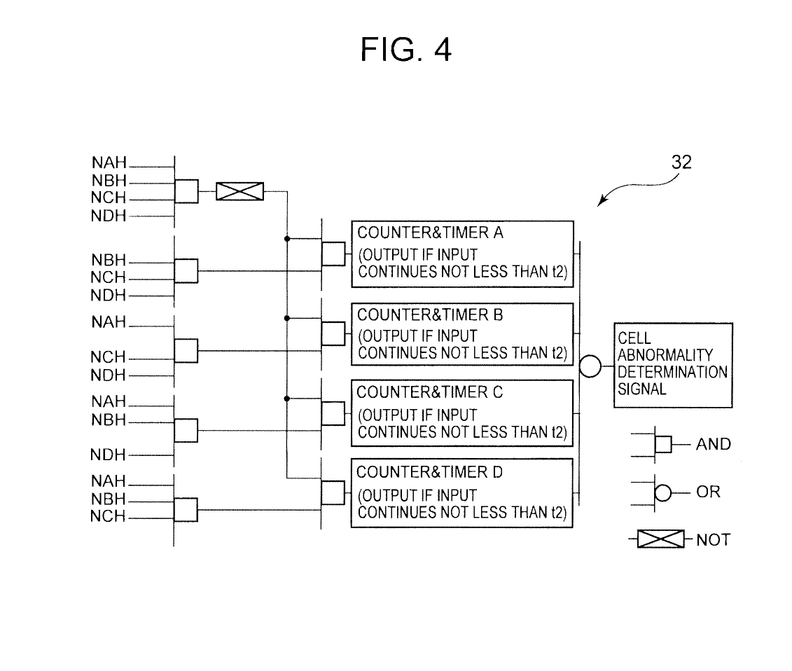

Now, the non-oscillating channel detecting section 32 will be described below by referring to FIG. 4.

FIG. 4 is a block diagram of the determination logic of the non-oscillating channel detecting section 32 of FIG. 2.

As shown in FIG. 4, when a state where only three inputs are found out of the four inputs continues for predetermined time period t2, the non-oscillating channel detecting section 32 outputs a cell abnormality determination signal. This state means that the remaining one input possibly shows a constant value due to a failure.

There can be cells each having only 3 or 2 channels due to layout or bypassing. The determination algorithm of such a cell is so designed as to check whether state where only two inputs out of three inputs are found or a state where only one input out of two inputs are found, whichever appropriate, continues for the predetermined time period t2 or not.

The determined abnormality is notified to the OPRM 9 by means of a text display on the front panel, an indicator display and/or an output of an alarm sound and to the outside or to the control room by outputting an alarm signal. As for the output to the outside, not only an alarm signal but also auxiliary information such as the cell number of the cell that produces an abnormal value, the LPRM detector number which detected an abnormal value and the like are output to provide the operator with information necessary for diagnosing the abnormality and/or the failure.

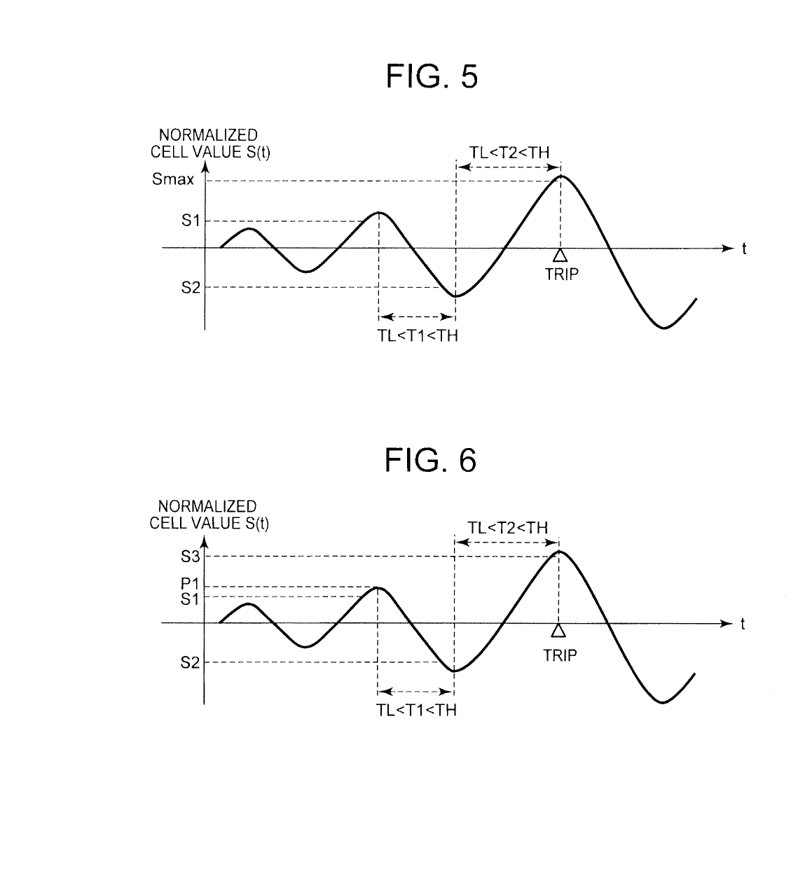

Now, the characteristics of the various trip determinations by the above-described trip determining section 5 will be described below by referring to FIGS. 5 through 7.

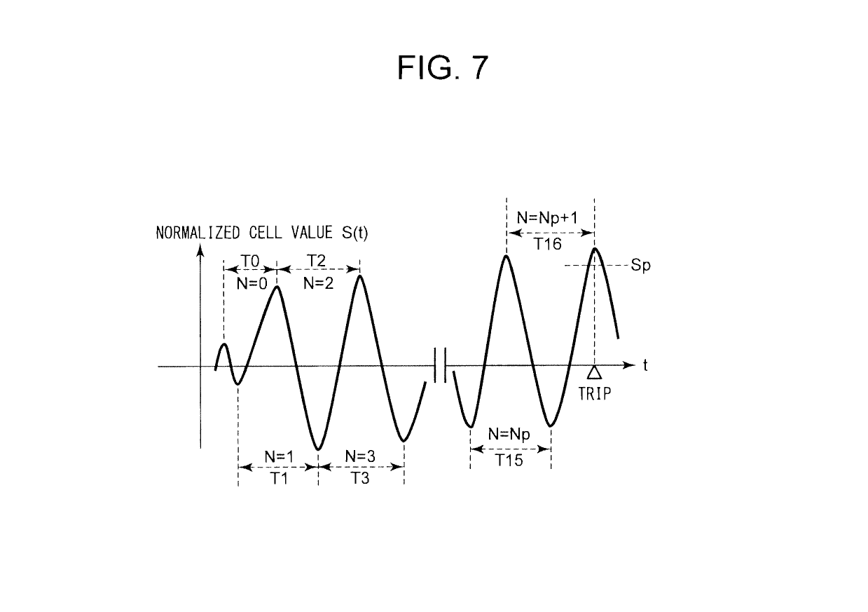

FIG. 5 is a graph schematically illustrating the operation of the ABA trip determining section 5a. FIG. 6 is a graph schematically illustrating the operation of the GRA trip determining section 5b. FIG. 7 is a graph schematically illustrating the operation of the PBDA trip determining section.

Firstly, the ABA trip determining section 5a will be described by referring to FIG. 5. ABA trip determination is conducted for each cell. The ABA trip determining section 5a follows the following steps for the determination.

1. The ABA trip determining section 5a compares the normalized peak value of cell value S(t) with determination threshold value S1.

2. When the normalized peak value exceeds the determination threshold value S1, the ABA trip determining section 5a compares the bottom value of the oscillation waveform with a second determination threshold value S2 and checks whether the time period T1 from clock time of the peak value to the clock time of the bottom value is found shorter than predetermined time period between TL and TH or not.

3. When the normalized peak value falls below S2, the ABA trip determining section 5a compares the next peak value with determination threshold value Smax and outputs an OPRM trip signal when the time period T2 between the clock time of the bottom value to the clock time of the peak value exceeds predetermined time period between TL and TH.

Now, the GRA trip determining section Sb will be described below by referring to FIG. 6. GRA trip determination is also conducted for each cell. The GRA trip determines a trip from the rate of a signal of cell oscillates and increases. The GRA trip determination that involves an algorithm similar to that of the ABA trip determination is conducted for each cell. The GRA trip determining section 5b follows the following steps for determination.

1. The GRA trip determining section 5b compares the normalized peak value of cell value S(t) with determination threshold value S1. This operation is similar to the corresponding operation of the ABA trip determining section 5a.

2. When the normalized peak value exceeds the determination threshold value S1, the GRA trip determining section 5b compares the bottom value of the oscillation waveform with a second determination threshold value S2 and checks whether the time period T1 from clock time of the peak value to the clock time of the bottom value is found shorter than predetermined time period between TL and TH. This operation is similar to the corresponding operation of the ABA trip determining section 5a.

3. When the normalized peak value falls below S2, the GRA trip determining section 5b calculates a trip determination threshold value S3 from the peak value P1 of the preceding cycle and the allowable maximum multiplication factor DR3 and outputs an OPRM trip signal when the signal exceeds S3.

Now, the PBDA trip determining section 5c will be described below by referring to FIG. 7. The PBDA trip determining section 5c determines a trip by monitoring the period of oscillation of the normalized cell value and detecting when the oscillation continuation number N indicating the number of periods that are continuous within a specified range and the normalized cell value S(t) for that exceed respective determination threshold values to determine a trip.

1. The PBDA trip determining section 5c checks whether the oscillation continuation number N indicating the number of periods (T0 to T16) during which the frequency is found within a specified range exceed a predetermined threshold value Np or not.

2. When, the oscillation continuation number N exceeds Np, the PBDA trip determining section 5c compares the normalized cell value S(t) with a trip determination threshold value Sp and outputs an OPRM trip signal when the normalized cell value S(t) exceeds Sp.

As described above, a change in the cell value that is the average value of the LPRM readings of 4 channels is detected in time series to determine an OPRM trip.

In this embodiment having the above-described configuration, the OPRM 9 may be formed by using an FPGA (field programmable gate array) that can operate at an improved processing speed and has a large scale capacity to monitor the amplitude of each LPRM reading. When two states including one showing an oscillation value and one showing a constant value are detected in the LPRM readings of the 4 channels of a cell, the operator can be made to recognize the sign of oscillations by displaying an alarm on the front panel of OPRM and/or outputting an alarm to the control room.

Note that the oscillation amplitude abnormality determining section 14 may be formed by the logic in the inside of the FPGA forming the noise removing filter 1, the averaging section 2, the time average processing section 3, the normalized cell value computing section 4 and the trip determining section 5. A space saving effect and an economizing effect can be achieved by using the same logic in the inside of the FPGA for two or more than two applications.

Additionally, the oscillation amplitude abnormality determining section 14 may be formed by an FPGA logic other than the FPGA forming the noise removing filter 1, the averaging section 2, the time average processing section 3, the normalized cell value computing section 4 and the trip determining section 5. The verification performance and the performance of separating functions when the FPGA falls into an abnormal state can be improved by using different FPGA logics.

For example, there can be a situation where the LPRM readings of three channels out of the four channels of the cell oscillate with the same amplitude and the LPRM reading of the remaining one channel shows a constant value because of a failure or a local abnormality of the oscillation mode in the reactor or a situation where the response is significantly slow. With this embodiment, when the cell average value is calculated by the averaging section 2 for each cell, the amplitude of oscillation of the normalized cell value can be smaller than the amplitude that is observed when the LPRM readings of all the four channels are oscillating. While the ABA trip determining section 5a and the GRA trip determining section 5b may not be able to detect the abnormality of the remaining one channel depending on the degree of reduction of amplitude, the amplitude abnormality determining section 13 can detect the abnormality of the remaining one channel.

As described above, since the OPRM system of this embodiment has a channel time average processing section 11, a channel normalizing section 12 and an amplitude abnormality determining section 13 arranged in parallel with the averaging section 2, it can determine whether each LPRM reading shows an abnormal value or not in parallel with operation of trip determination of each of the actually measured and normalized cell values of the cells 1 to 44.

Thus, the OPRM system of this embodiment can detect any abnormal cell and/or any abnormal LPRM detector with ease to make it possible to obtain an OPRM with an improved reliability of trip determination. Additionally, the performance of the embodiment can be further improved when the OPRM 9 is formed by using an FPGA that can operate at an improved processing speed and has a large scale capacity.

### Second Embodiment

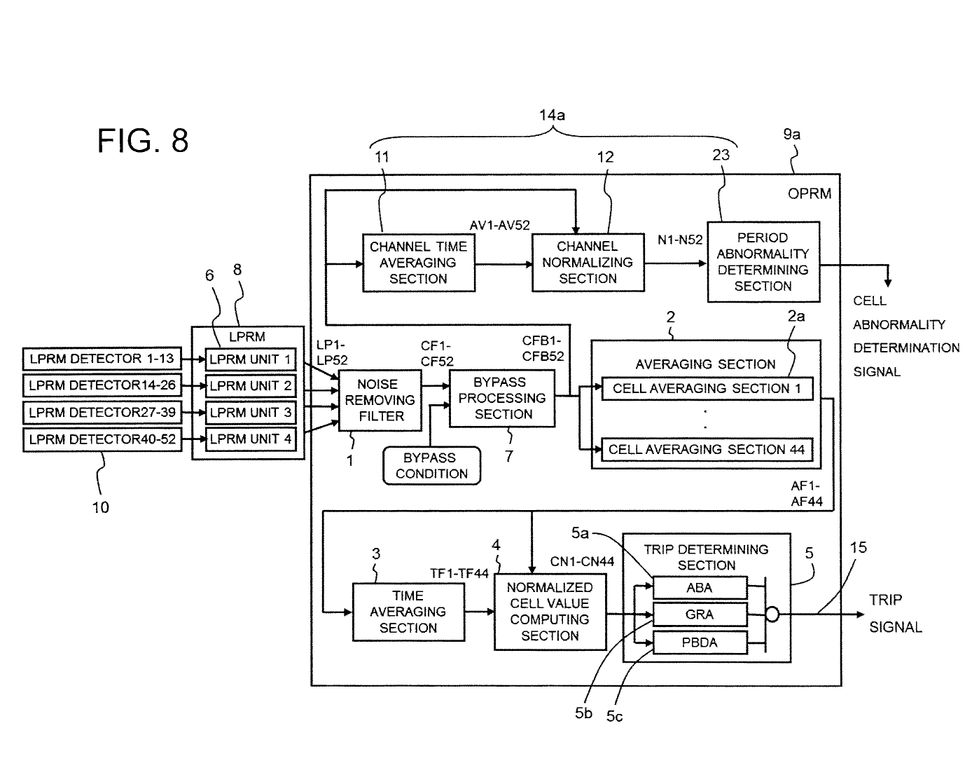

FIG. 8 is a block diagram of OPRM according to the second embodiment of the present invention, illustrating the configuration thereof.

In this embodiment, the oscillation amplitude abnormality determining section 14 shown in FIG. 1 is replaced by an oscillation period abnormality determining section 14a. The parts of this embodiment that are the same as or similar to those shown in FIG. 1 are denoted by the common reference symbols and will not be described repeatedly.

Referring to FIG. 8, the OPRM 9a has an oscillation period abnormality determining section 14a for detecting whether fluctuations of the period of oscillation of the LPRM reading of each LPRM detector assigned to a cell are within a predetermined range or not and determining any abnormality.

The period abnormality determining section 14a includes a channel time averaging section 11, a channel normalizing section 12 and an oscillation period abnormality determining section 23.

The channel time average processing section 11 operates for a time averaging process to calculate channel time average values AV1 to AV52 and outputs them to the channel normalizing section 12. The channel normalizing section 12 outputs channel normalized values N1 to N52 to the period abnormality determining section 23.

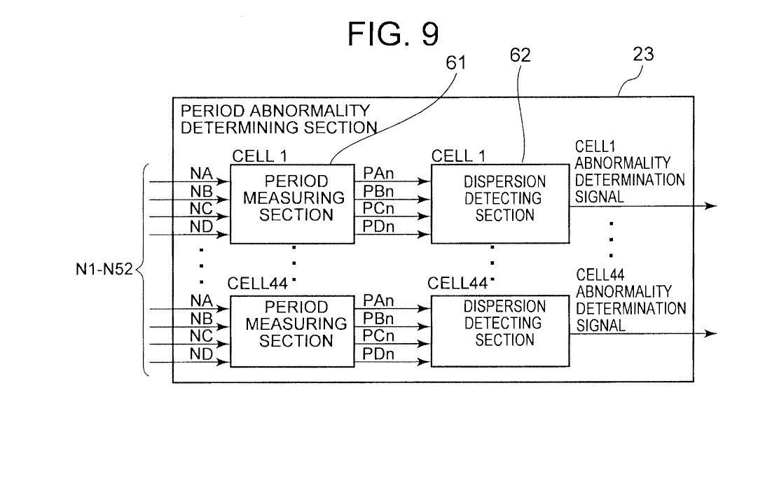

Now, the period abnormality determining section 23 will be described below by referring to FIG. 9.

The period abnormality determining section 23 distributes the channel normalized values N1 to N52 to 44 period measuring sections 61 that correspond to 44 cells. The four channel normalized values NA, NB, NC and ND that are input to each period measuring section 61 correspond to the outputs of the LPRM detectors 10 arranged in the four regions in the height direction A, B, C and D of the LPRM detector assembly.

The period measuring section 61 determines whether the amplitude of any of the four channel normalized values NA, NB, NC and ND exceeds a determination threshold value or not, measures the period of the oscillations during the time when the amplitude exceeds the determination threshold value and outputs it to dispersion detecting section 62.

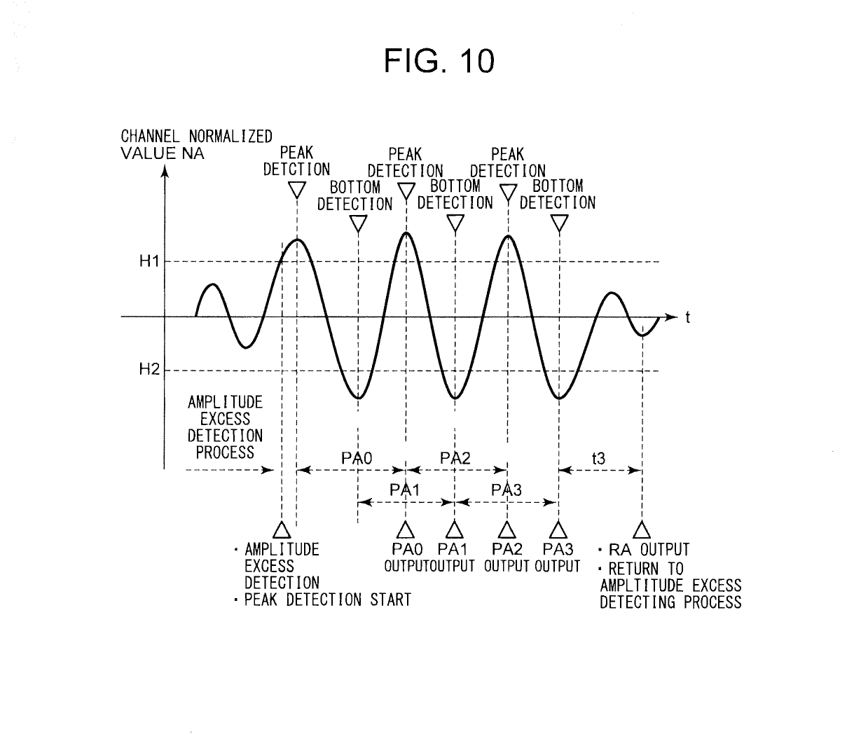

Now, the period measuring section 61 will be described below by referring to FIG. 10.

While the executing process of channel normalized value NA is described here, the period measuring section 61 executes a similar process for NB, NC and ND each.

Firstly, the period measuring section 61 compares the channel normalized value NA with a determination threshold value H1. If the channel normalized value NA exceeds the determination threshold value H1, the period measuring section 61 operates to detect a peak. When the period measuring section 61 detects peaks, it starts measuring the period of the peaks. Then, the period measuring section 61 compares the channel normalized value NA with determination threshold value H2 and checks whether the channel normalized value NA falls below the determination threshold value H2 in a predetermined time period t3 or not.

The reason why the determination threshold values H1 and H2 are set is to remove the influence of the fluctuations and noise that each channel normalized value contains and selectively detect oscillations. A value similar to the determination threshold value S1 for ABA trip, which may typically be equal to 1.1 as ratio to the determination threshold value S1, is selected for an absolute value of the determination threshold values H1, H2 each.

When the channel normalized value NA falls below the determination threshold value H2, the period measuring section 61 operates to detect bottoms. When the period measuring section 61 detects bottoms, it starts measuring the period of the bottoms. Then, the period measuring section 61 compares the channel normalized value NA with the determination threshold value H1 and checks whether the channel normalized value NA exceeds the determination threshold value H1 in predetermined time period t3 or not. If the channel normalized value NA exceeds the determination threshold value H1, the period measuring section 61 then operates to detect peaks. When the period measuring section 61 detects peaks, it outputs the result of measuring the period of the peaks PA0 to dispersion detecting section 62 and starts measuring the period of the next peak.

Thereafter, the period measuring section 61 compares the channel normalized value NA with the determination threshold value H2 and checks whether the channel normalized value NA falls below H2 in predetermined time period t3 or not. When the channel normalized value NA falls below the determination threshold value H2, the period measuring section 61 operates to detect bottoms. When the period measuring section 61 detects bottoms, it outputs the result of measuring the period of the bottoms PA1 to the dispersion detecting section 62 and starts measuring the period of the next bottom.

Thereafter, the period measuring section 61 keeps on measuring the periods in the above-described manner. If NA neither exceeds the determination threshold value H1 nor falls below the determination threshold value H2 in predetermined time period t3, the period measuring section 61 outputs period reset signal RA to the dispersion detecting section 62 and returns to the amplitude excess detecting process. The above-described processing operations are conducted also for the channel normalized values NB, NC and ND and the period measuring section 61 outputs periods PBn, PCn, PDn (n=0, 1, 2, 3, . . . ) and reset signals RB, RC, RD to the dispersion detecting section 62 under the some conditions.

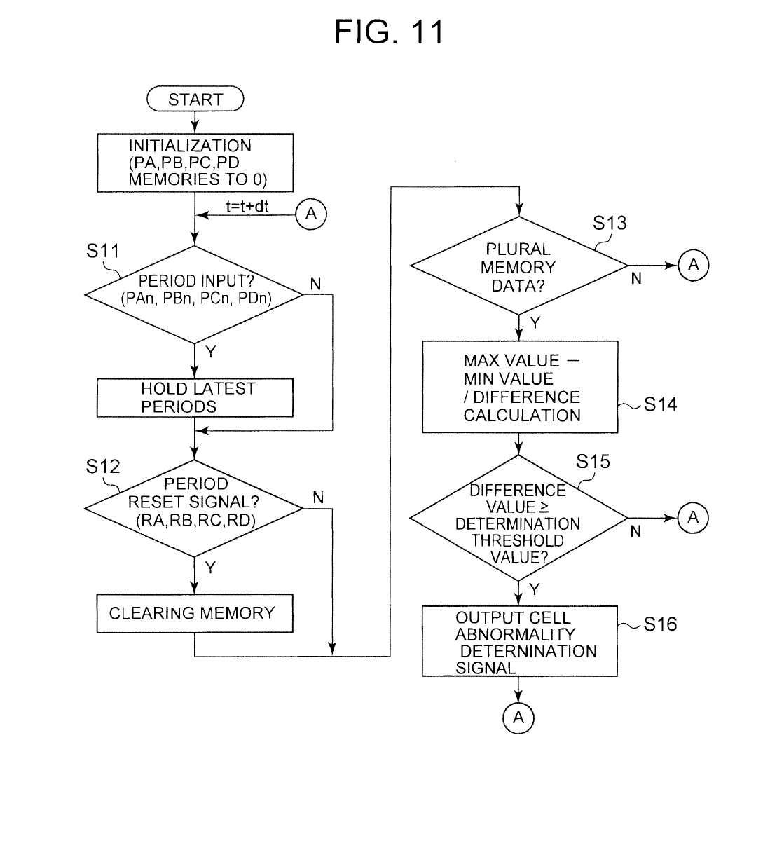

Now, the dispersion detecting section 62 will be described below by referring to FIG. 11.

The dispersion detecting section 62 holds the latest periods PAn, PBn, PCn and PDn (step S11). The initial values are equal to 0. The period of each channel held by the dispersion detection section 62 is cleared to 0 by a period reset signal of the channel (step S12).

The dispersion detecting section 62 calculates the difference between the largest value and the smallest value in the period data of each of the four channels it holds at every predetermined time interval dt(step S14). This calculation is executed on a real time basis and it is not necessary for the “n” values of the periods to agree with each other. Any data on zero is not used for calculations. The difference between the largest value and the smallest value can be calculated only when the number of data in the memory is not less than two (step S13). An upper threshold value is defined to the difference between the largest value and the smallest value and a cell abnormality determination signal is output when the threshold value is exceeded. This abnormal state means that the periodicity of periods may possibly be disturbed because of a single LPRM reading showing a different period.

Note that a dispersion value may be utilized for abnormality determination instead of the calculation of the difference between the largest value and the smallest value. Then, an upper threshold value is defined to the dispersion value and a cell abnormality determination signal is output when the threshold value is exceeded (steps S15 and S16).

Additionally, as a feature for assisting the abnormality determination, upper and lower threshold values both may be used for each period value. Then, an upper threshold value and lower threshold value are defined for each period and a cell abnormality determination signal is output when these threshold values are overstepped. A cell abnormality determination signal may be output by using the logical sum of the results of determinations obtained for an arbitrary combination of the period, the dispersion value, the difference between the largest value and the smallest value.

Thus, the OPRM 9a can determine a period abnormality of each LPRM reading.

In this embodiment having the above-described configuration, the OPRM 9a may be formed by using an FPGA that can operate at an improved processing speed and has a large scale capacity to monitor the period of each LPRM reading. When a large dispersion is detected among the monitored periods of the four channels of a cell, the operator can be made to recognize the sign of oscillations by displaying an alarm on the front panel of the OPRM and/or outputting an alarm to the control room.

Thus, with this embodiment, if three LPRM readings oscillate with the same period out of the four LPRM readings of the four channels of a cell while the LPRM reading of the remaining one channel shows a period different from the other three channels because the LPRM detector of that channel is in Lrouble, for example, and the average value of the cell is calculated by the averaging section 2, the amplitude of the oscillations of the normalized cell value is smaller than the average value that is obtained when all the four LPRM readings oscillate with the same period due to the LPRM reading whose oscillations are out of phase. While the ABA trip determining section 5a and the GRA trip determining section 5b may not be able to detect the abnormality of the remaining one channel depending on the degree of amplitude and, additionally, the periodicity of periods may be disturbed due to the LPRM reading whose oscillations are out of phase but the PBDA trip determining section 5c may not be able to detect it. However, the period abnormality determining section 23 can detect the abnormality of the one channel.

As described above, since this embodiment has a channel time average processing section 11, a channel normalizing section 12 and a period abnormality determining section 23 arranged in parallel with the averaging section 2, it can determine whether each LPRM reading shows an abnormal value or not in parallel with operation of trip determination of each of the actually measured and normalized cell values of the cells 1 to 44.

Thus, according to this embodiment, the OPRM can detect any abnormal cell and/or any abnormal LPRM detector with ease to make it possible to obtain an OPRM with an improved reliability of trip determination. Additionally, the performance of the OPRM system of the embodiment can be further improved when the OPRM 9a is formed by using an FPGA that can operate at an improved processing speed and has a large scale capacity.

### Third Embodiment

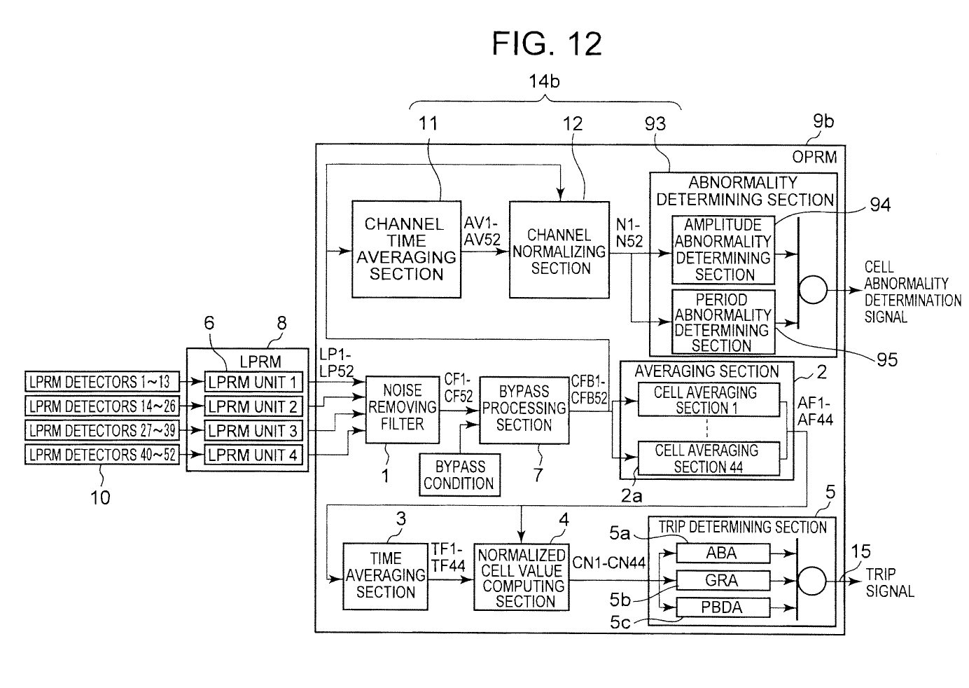

FIG. 12 is a block diagram of an OPRM 9b according to the third embodiment of the present invention, illustrating the configuration thereof. In this embodiment the oscillation amplitude abnormality determining section 14 shown in FIG. 1 is replaced by an oscillation amplitude/period abnormality determining section 14b. The parts of this embodiment that are the same as or similar to those shown in FIG. 1 are denoted by the common reference symbols and will not be described repeatedly.

The OPRM 9b additionally has an oscillation amplitude/period abnormality determining section 14b for detecting an LPRM reading that does not show a predetermined oscillation pattern on the basis of the LPRM readings assigned to each cell and also detecting whether fluctuations of the period of oscillation of the LPRM reading of each LPRM detector assigned to a cell are within a predetermined range or not and determining any abnormality.

The oscillation amplitude/period abnormality determining section 14b includes a channel time averaging section 11, a channel normalizing section 12 and an abnormality determining section 93. The abnormality determining section 93 by turn includes an amplitude abnormality determining section 94 and a period abnormality determining section 95.

The amplitude abnormality determining section 94 has a function same as the amplitude abnormality determining section 13 of the oscillation amplitude abnormality determining section 14 in FIG. 1. The period abnormality determining section 95 has a function same as the period abnormality determining section 23 of the oscillation period abnormality determining section 14a in FIG. 8. Thus, the abnormality determining section 93 has the abnormality determining functions of the two sections in combination.

In this embodiment having the above-described configuration, the OPRM 9b may be formed by using an FPGA that can operate at an improved processing speed and has a large scale capacity to monitor the amplitude of each LPRM reading. When two states including one showing an oscillating value and one showing a constant value are detected or when a large dispersion is detected among the monitored periods of the four channels of a cell, the operator can be made to recognize the sign of oscillations by displaying an alarm on the front panel of the OPRM and/or outputting an alarm to the control room.

As described above, the OPRM system according to this embodiment has a channel time average processing section 11, a channel normalizing section 12, an amplitude abnormality determining section 94 and a period abnormality determining section 95 arranged in parallel with the averaging section 2. Then, the OPRM system can determine whether each LPRM reading shows an abnormal value or not in parallel with operation of trip determination of each of the actually measured and normalized cell values of the first to 44th cells.

Thus, the OPRM system of this embodiment can detect any abnormal cell and/or any abnormal LPRM detector with ease to make it possible to obtain an OPRM with an improved reliability of trip determination. Additionally, the performance of the embodiment can be further improved when the OPRM 9b is formed by using an FPGA that can operate at an improved processing speed and has a large scale capacity.

The first through third embodiments are described above in terms of ABWR (advanced boiling water reactor), the present invention is similarly applicable to any other types of BWRs by appropriately adjusting the number of channels and the number of cells of all the LPRM detectors.

As for abnormality determination, the logical sum of the above-described outcome of abnormality determination, the output of the ABA trip determining section 5a, that of the GRA trip determining section 5b and that of the PBDA trip determining section 5c may be output as a trip in addition to the result of abnormality determination.

While certain embodiments have been described, these embodiments have been presented by way of example only, and are not intended to limit the scope of inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An oscillation power range monitor comprising:
an averaging section that assigns a plurality of LPRM readings input from local power range monitors to cells operating as computing units and calculates cell average value of the LPRM readings assigned to each cell;
a time average processing section that receives the average value of each cell as input and calculates a cell time average value;
a normalized cell value computing section that receives the cell time average value and the cell average value as input and computes a normalized cell value for each cell;
a trip determining section that receives the normalized cell value as input, monitors oscillations of output of each cell and outputs a scram trip when the normalized cell value exceeds a predetermined value; and
an abnormality determining section that determines abnormality of each of the LPRM readings assigned to each cell on the basis of the oscillations of the LPRM reading.

2. The oscillation power range monitor according to claim 1, wherein
the abnormality determining section includes:
a channel time averaging section that receives the plurality of LPRM readings as inputs and calculates a channel time average value of each LPRM reading;
a channel normalizing section that receives the plurality of LPRM readings and the channel time average value of each LPRM reading as inputs and calculates a channel normalized value of each LPRM reading; and
an abnormality determining section that assigns the channel normalized values output from the channel normalizing section among the cells operating as computing units and determines abnormality by means of the channel normalized values assigned to the cells.

3. The oscillation power range monitor according to claim 2, wherein
the abnormality determining section has:
an oscillation abnormality determining section including: an amplitude excess determining section for detecting any amplitude exceeding the channel normalized value assigned to each cell and outputting a specified amplitude exceeding signal relative to each channel normalized value; and non-oscillating channel detecting section for receiving the specified amplitude exceeding signal relative to each channel normalized value, comparing the received specified amplitude exceeding signal, detecting a channel normalized value showing a small oscillation and outputting an abnormality determination signal; and
a period measuring section for measuring the period of each channel normalized value assigned to each cell and a dispersion detecting section for measuring the dispersion of the period measured on a basis of cell unit and outputting an abnormality determination signal for any dispersion exceeding a determination threshold value.

4. The oscillation power range monitor according to claim 2, wherein
the abnormality determining section includes:
an oscillation abnormality determining section that detects any channel normalized value not showing predetermined oscillations for abnormality determination; and
a period abnormality determining section that detects the period of any channel normalized value oscillating out of a predetermined range for abnormality determination.

5. The oscillation power range monitor according to claim 2, wherein
the abnormality determining section includes:
a period measuring section that measures a period of each channel normalized value assigned to each cell; and
a dispersion detecting section that measures dispersion of the period measured on basis of cell unit and outputs an abnormality determination signal for any dispersion exceeding a determination threshold value.

6. The oscillation power range monitor according to claim 2, wherein
the abnormality determining section is a period abnormality determining section that detects a period of any channel normalized value oscillating out of a predetermined range for abnormality determination.

7. The oscillation power range monitor according to claim 2, wherein
the abnormality determining section is an oscillation abnormality determining section including: an amplitude excess determining section that detects any amplitude exceeding of channel normalized value assigned to each channel and outputs a specified amplitude exceeding signal relative to each channel normalized value; and a non-oscillating channel detecting section that receives the specified amplitude exceeding signal relative to each channel normalized value, compares the received specified amplitude exceeding signal, detects a channel normalized value showing a small oscillation and outputs an abnormality determination signal

8. The oscillation power range monitor according to claim 2, wherein
the abnormality determining section is an oscillation abnormality determining section that detects a channel normalized value not showing predetermined oscillations for abnormality determination.

9. The oscillation power range monitor according to claim 3, wherein
the dispersion detecting section makes use of a difference between a largest value and a smallest value for detecting the dispersion of the period.

10. The oscillation power range monitor according to claim 3, wherein
the dispersion detecting section makes use of a variance value for detecting the dispersion of the period.

11. The oscillation power range monitor according to claim 3, wherein
the dispersion detecting section defines upper and lower threshold values as a feature for assisting the detection of the dispersion of the period and makes use of the upper and lower threshold values for determination.

12. The oscillation power range monitor according to claim 1, wherein
the abnormality determining section outputs a result of abnormality determination at least by means of a text display on an oscillation range monitor, an indicator display, an output of an alarm sound or an alarm signal.

13. The oscillation power range monitor according to claim 1, wherein
the abnormality determining section outputs auxiliary information including a cell number of the cell that produces an abnormal value and/or an LPRM detector number of an LPRM detector that has detected an abnormal value in addition to a result of abnormality determination.

14. The oscillation power range monitor according to claim 1, wherein
the monitor outputs a trip signal as logical sum of an output of a result of abnormality determination from the abnormality determining section and a trip signal output from the trip determining section.

15. The oscillation power range monitor according to claim 1, wherein
the averaging section, the time average processing section, the normalized cell value computing section, the trip determining section and the abnormality determining section are formed by using at least one first FPGA.

16. The oscillation power range monitor according to claim 15, wherein
the abnormality determining section is formed by using logics in the insides of the FPGAs of the averaging section, the time average processing section, the normalized cell value computing section and the trip determining section.

17. The oscillation power range monitor according to claim 15, wherein
the abnormality determining section is formed by using a logic in the inside of at least one second FPGA different from the first FPGA.

18. A method of checking soundness of an oscillation power range monitor, the method comprising:
an averaging step of assigning a plurality of LPRM readings input from local power range monitors to cells operating as computing units and calculating a cell average value of the LPRM readings assigned to each of the cells;
a time average processing step of receiving the average value of each cell as input and calculating a cell time average value;
a normalized cell value computing step of receiving the cell time average value and the cell average value as input and computing the normalized cell value for each of the cells;
a trip determining step of receiving the normalized cell value as input, monitoring oscillations of the output of each cell and outputting a scram trip when the normalized cell value exceeds a predetermined value; and
an abnormality determining step of determining abnormality of each of the LPRM readings assigned to each cell on the basis of the oscillations of the LPRM reading.

19. The method of checking the soundness of an oscillation power range monitor according to claim 18, wherein
the abnormality determining step includes:
an oscillation abnormality determining step of detecting any channel normalized value not showing predetermined oscillations for abnormality determination.

20. The method of checking the soundness of an oscillation power range monitor according to claim 18, wherein
the abnormality determining step includes:
a period abnormality determining step of detecting the period of any channel normalized value oscillating out of a predetermined range for abnormality determination.
